(19) United States
(12) Patent Application Publication
(10) Pub. No.: US 2026/0065382 A1
(43) Pub. Date: Mar. 5, 2026

(54) CROP ROTATION BASED COMPUTER-IMPLEMENTED METHOD FOR ESTIMATING A CONSUMPTION OF AN AGRICULTURAL PRODUCT FOR A GEOGRAPHICAL REGION

(71) Applicant: BASF SE, Ludwigshafen am Rhein (DE)

(72) Inventors: Thomas CHRISTEN, Limburgerhof (DE); Christoph LOEFFEL, Limburgerhof (DE); Joerg HUENNINGHAUS, Ludwigshafen am Rheim (DE)

(21) Appl. No.: 19/104,154

(22) PCT Filed: Aug. 4, 2023
(86) PCT No.: PCT/EP2023/071651

§ 371 Date: Feb. 14, 2025

(30) Foreign Application Priority Data
Aug. 16, 2022 (EP) 22190499.8

(51) Int. Cl. G06Q 50/02; G06Q 10/04; G06V 20/10; G06V 20/13

(52) U.S. Cl. CPC G06Q 50/02; G06Q 10/04; G06V 20/13; G06V 20/188

(57) ABSTRACT

The invention relates to a computer-implemented method for estimating a consumption of an agricultural product for a geographical region by using, among other elements, historic satellite imaging data for the geographical region and a crop rotation model for classifying crop rotation patterns in the geographic region; it also relates to the use of historic satellite imaging data for a geographical region in such a method; a system for estimating a consumption of an agricultural product for a geographical region, the system being configured to carry out said method; a computer program element with instructions, which when executed on one or more computing node(s) is configured to carry out the steps of said method; and a computer-readable medium having stored the computer program element.

### TECHNICAL FIELD

The present disclosure relates to a computer-implemented method for estimating a consumption of an agricultural product for a geographical region, the use of historic satellite imaging data for a geographic region of the previous growing season and at least one further historic growing season in said method; a system for estimating a consumption of an agricultural product for a geographical region; a computer program element and a computer-readable medium. These and further aspects are reflected in the claims and the specification below. All embodiments, preferences and aspects described herein for the computer-implemented method are also disclosed in connection to the use of historic satellite imaging data, the system, the computer program element, other computer-implemented methods according to the invention, and the computer-readable medium.

### TECHNICAL BACKGROUND

In agriculture, many agricultural products (e.g. seeds, pesticides, fertilizers, etc.) have to be applied or delivered to an agricultural field by the farmer at a specific time or time frame and it is thus very important that the required agricultural products can be delivered to the farmer at these defined times. However, the production and transportation of many of these agricultural products require a certain lead time before they can be delivered to a farmer. For this reason, in the production of agricultural products, purchasing, storage and other logistical sub-areas of agriculture, the manufacturers, suppliers and subcontractors must estimate the necessary quantities of the agricultural products required by the agriculture for a certain period of time in order to be able to reliably provide the corresponding quantities of the required agricultural products. Until now, the required quantities of agricultural products have often been estimated based on manufacturers'many years of experience. However, in practice this also has led to deviations between the estimated quantity and the quantity actually required, which is of considerable disadvantage in the case of overproduction with agricultural products that cannot be stored easily and/or agricultural products that can only be stored at high cost. In addition, supply bottlenecks may occur, if the estimate was too low. It is further required to have an accurate estimation as early as possible to initiate appropriate steps to match the supply with the upcoming demand.

Thus, it has been found that a further need exists to provide means to estimate a consumption of an agricultural product for a geographical region as accurately and as early as possible.

Thus, it is an object of the present invention to provide means, e.g. methods, systems, etc., to estimate a consumption of an agricultural product for a geographical region in an accurate way as early as possible before the demand for the agricultural product arises. These and other objects, which become apparent upon reading the following description, are solved by the subject matter of the independent claims. The dependent claims refer to preferred embodiments of the invention.

### SUMMARY OF THE INVENTION

A first aspect of the present disclosure relates to a computer-implemented method for estimating a consumption of an agricultural product for a geographical region, the method comprising the steps:
providing (110) historic satellite imaging data for the geographical region of the previous growing season and at least one further historic growing season;
determining (120) historic crop classification data from at least the historic satellite imaging data, the historic crop classification data comprising information on the crop types grown on the agricultural fields in the geographic region for the at least two historic growing seasons;
providing (130) a crop rotation model for classifying crop rotation patterns in the geographic region, the model at least being based on the historic crop classification data for the geographic region;
determining (140) crop rotation patterns of agricultural fields in the geographic region based on the historic crop classification data of the agricultural fields by using the crop rotation model;
determining (150) future crop data comprising information on the area of the geographic region cultivated with a specific crop in the current or the next growing season at least based on the historic crop classification data of the agricultural fields by using the crop rotation patterns of the agricultural fields;
providing (160) a product consumption model for the agricultural product configured to estimate a consumption of the agricultural product at least based on the future crop data;
providing (170) an estimation of the consumption of the agricultural product for the geographical region at least based on the future crop data using the product consumption model.

A second aspect of the present disclosure relates to the use of satellite imaging data for a geographical region of the previous growing season and at least one further historic growing season in a method as defined above.

A third aspect of the present disclosure relates to a system for estimating a consumption of an agricultural product for a geographic region, the system comprising:
one or more computing nodes and one or more computer-readable media having thereon computer-executable instructions that are structured such that, when executed by the one or more computing nodes, cause the system to perform the following steps:
providing (110) historic satellite imaging data for the geographical region of the previous growing season and at least one further historic growing season;
determining (120) historic crop classification data from at least the historic satellite imaging data, the historic crop classification data comprising information on the crop types grown on the agricultural fields in the geographic region for the at least two historic growing seasons;
providing (130) a crop rotation model for classifying crop rotation patterns in the geographic region, the model at least being based on the historic crop classification data for the geographic region;
determining (140) crop rotation patterns of agricultural fields in the geographic region based on the historic crop classification data of the agricultural fields by using the crop rotation model;
determining (150) future crop data comprising information on the area of the geographic region cultivated with a specific crop in the current or the next growing season at least based on the historic crop classification data of the agricultural fields by using the crop rotation patterns of the agricultural fields;
providing (160) a product consumption model for the agricultural product configured to estimate a consumption of the agricultural product at least based on the future crop data;
providing (170) an estimation of the consumption of the agricultural product for the geographical region at least based on the future crop data using the product consumption model.

In a fourth aspect the present disclosure relates to a computer program element with instructions, which when executed on one or more computing node(s) is configured to carry out the steps of the method defined above.

In a fifth aspect the present disclosure relates to a computer readable medium having stored the computer program element.

In a sixth aspect the present invention relates to a method of production of an agrochemical product for a geographical region, the method comprising the steps:
providing (110) historic satellite imaging data for the geographical region of the previous growing season and at least one further historic growing season;
determining (120) historic crop classification data from at least the historic satellite imaging data, the historic crop classification data comprising information on the crop types grown on the agricultural fields in the geographic region for the at least two historic growing seasons;
providing (130) a crop rotation model for classifying crop rotation patterns in the geographic region, the model at least being based on the historic crop classification data for the geographic region;
determining (140) crop rotation patterns of agricultural fields in the geographic region based on the historic crop classification data of the agricultural fields by using the crop rotation model;
determining (150) future crop data comprising information on the area of the geographic region cultivated with a specific crop in the current or the next growing season at least based on the historic crop classification data of the agricultural fields by using the crop rotation patterns of the agricultural fields;
providing (160) a product consumption model for the agricultural product configured to estimate a consumption of the agricultural product at least based on the future crop data; providing (170) an estimation of the consumption of the agricultural product for the geographical region at least based on the future crop data using the product consumption model;
providing (180) control data for a manufacturing process with respect to the agricultural product based on the estimation of the consumption of the agricultural product;
producing (190) the agrochemical product by using the control data in the manufacturing process.

Any disclosure and embodiments described herein relate to the methods, the system, the use, the computer program element and the computer readable medium lined out above and vice versa. Advantageously, the benefits provided by any of the embodiments and examples equally apply to all other embodiments and examples and vice versa.

The present disclosure is, inter alia, based on the finding that by means of a crop rotation model for classifying crop rotation patterns in a geographic region in combination with historic crop classification data containing information on the crop types grown on the agricultural fields in the geographic region, it can be determined which areas of a geographical region are cultivated with which crops in the current or the next growing season. Based on the information about the area, i.e. the size of the area, it is possible to estimate the consumption of an agricultural product for the geographical region. As a result, manufacturing processes, logistics processes and warehouse activities can be planned and executed in a much safer and more predictable manner, significantly reducing the associated costs of planning and occurring forecast errors. Moreover, since agricultural products may also be used until it's expiry dates, the present disclosure allows to significantly reduce that agricultural products must be disposed of.

### DEFINITIONS

The term “agricultural product” is to be understood broadly in the present disclosure and comprises any object or material useful/required for the treatment of an agricultural field. In the context of the present disclosure, the term agricultural product includes but is not limited to:
chemical products such as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or any combination thereof;
biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof;
fertilizer and nutrient;
seed and seedling;
water;
agricultural equipment/devices, e.g. sprayers, harvesters, machines, and spare parts for such equipment/devices; and/or
any combination thereof.

The term “agricultural field” relates to an arable piece of land where crop plants, such as fruits and vegetables, or row crops such as corn or rapeseed will be grown, are grown and/or were grown for at least one previous growing season. The term “field” includes both the entire field and parts thereof, such as half of an agricultural field or a third thereof. Agricultural field does not relate to covered facilities such as greenhouses.

The term “geographic region” has to be understood broadly in the present disclosure and ranges from an area covering several agricultural fields of a farmer or several farmers to districts, states, entire countries (e.g. Germany), or even continents, such as Europe. In one aspect, the term “geographic region” relates to a territory controlled by a common legislative body. Preferably, the term geographical region can be understood to mean, for example, a county/district, a region such as southern Bavaria or the like. The geographical region can be chosen in such a way that the product consumption can be estimated for a delivery area of a producer. Particularly preferably, the term geographical region is understood to mean an area of more than 400 square kilometers. In another aspect, the term “geographic region” relates to a region of the same climate classification, such as a climate zone. Examples of a climate classification is for example the classification according to Koppen and Geiger, and the Trewartha climate classification. Climate classifications strongly correlate with the types of crops cultivated in a geographic region, the length, number, and start/end of periods over the year that allow for growth the specific crop. The term “geographic region” may also relate to an intersection of a zone within a climate class and a territory controlled by a common legislative body, such as Mediterranean countries in the European Union. It may also relate to a subset of territories within a zone of the same climate classification, such as east Germany, Poland and Czech Republic.

The term “crop vegetation index data” is to be understood broadly and comprises any crop growth index data allowing to determine at least the type of crop cultivated in the geographical region, such as by comparison with reference data. In an example, the crop growth index data may be Normalized Difference Vegetation Index (NDVI) data and the reference data may be crop specific NDVI data. The reference data, for example the NDVI data, can be used not only to determine the specific crop by comparison of the data, but also, for example, to determine or compare whether the specific crop is healthy, damaged or diseased. The latter can be compared, specified and quantified particularly well with NDVI data, since crop leaves reflect the light differently according to their condition. The historic crop vegetation index data comprises data of the previous growing season and at least one further historic growing season. The term “growing season” refers to a portion of the year that allows for active plant growth of the particular crop and typically varies between crop types. Accordingly, the term “last growing season” would always refer to the specific crop in question, and describes the last, past period during which the crop could be grown in the geographic region under the prevailing climatic conditions.

The term “crop classification data” refers to information on the crop types grown on the agricultural fields in the geographic region. In other words, the historic crop classification data classifies agricultural fields according to the type of crop grown thereon. The historic crop classification data is determined from at least the historic vegetation index data, such as by comparison with plant-specific reference data.

The term “plant-specific reference data” refers to any data which allows to conclude on a specific crop by comparing the provided satellite imaging data, preferably the crop vegetation index data, with the reference data. In an example, the “plant-specific reference data” may be used to train a machine-learning algorithm which in turn may specify the specific crop cultivated in the geographical region.

The term “machine-learning algorithm” has to be understood broadly and preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

The term “crop”, as used for example in “crop type” may refer to a plant such as a grain, fruit, or vegetable grown in large amounts. Preferred crops are: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea may. Most preferred crops are: Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays.

The term “crop rotation model” is to be understood broadly in the present disclosure and refers to any computer-operable model, method, mathematical algorithm, which can be used to classify crop rotation patterns in the geographic region, wherein the model is based on the historic crop classification data for the geographic region. Accordingly, the crop rotation model summarizes the historic crop classification data for the geographic region, and further classifies the agricultural fields according to crop rotation pattern. The term “crop rotation pattern” refers to the sequence of crops over at least two subsequent growing periods, typically at least the three last growing periods, especially at least four growing periods, such as at least 5 growing periods. For example, the historic crop classification data for the geographic region may indicate for certain areas that a specific crop A is typically followed by crop B (pattern 1) in the subsequent growing season, whereas it is followed by crop C (pattern 2) in other areas of the geographic region. In such a case, the crop rotation model may contain information two different crop rotation patterns. The crop rotation model may take into account more than just the historic crop classification data. In one embodiment, the crop rotation model may also be based on traditional crop rotation patterns, such as the three-field rotation system, the four-field rotation system, and considerations on soil organic matter, pest management, nutrients, soil erosion, interbreed generation, impacts on surrounding fields, etc. For example, the crop rotation model may include information on a four-field rotation system of the classic crops wheat, turnip, barley, and clover; or oilseed rape, wheat, barley and legumes. In another example, the crop rotation model may include information on a two-field rotation system, such as the oilseed rape and wheat system. In another embodiment, the crop rotation model may further take into account rules and recommendations on crop rotation patterns by local authorities and environmental agencies, such as governmental organizations and farmer associations. Such rules and recommendations may differ from region to region including their goals, such as increased yield, soil protection, biodiversity, or reduction of crop protection agents. Accordingly, region-specific information on regulation of crop rotation practices are typically taken into account in the crop rotation model.

An “area of a geographical region cultivated with a specific crop” means the area of the geographic region that has been or will be planted with a specific crop. In other words, the “area of a geographical region cultivated with a specific crop” is the area that results from adding up the respective agricultural fields on which the specific crop is or will be grown in the geographical region. For example, if wheat is grown on 100 individual fields of 2 hectares each, whereby the individual fields can be distributed arbitrarily in the geographical region, then the “area of a geographical region cultivated with a specific crop” is 200 hectares. Based on this area, the consumption of an agricultural product needed for the treatment of the determined area can then be estimated. In an example, the “area” may be expressed in hectares, square meters, square kilometers or similar. The term “area of a geographical region cultivated with a specific crop” as used in step (150) in the term “determining (150) future crop data comprising information on the area of the geographic region cultivated with a specific crop” includes the determination of several areas cultivated with different crops, such as the determination of the area of a geographic region cultivated with winter wheat and the area cultivated with corn. Accordingly, the inventive method can not only achieve the estimation of the consumption of an agricultural product based on the area of cultivation of one specific crop but can also account for the consumption based on areas of cultivation of various crop types, such as in case the agricultural product can be used on more than one crop.

The term “crop growth model” shall be understood broadly in the present disclosure and refers to any computer-operable model, method, mathematical algorithm, which can be used to calculate the growth stage for a time t2 based on the growth stage of the specific crop at a time t1. An example for such a cop growth model is explained in the paper “Use time series NDVI and EVI to develop dynamic crop growth metrics for yield modeling” (Sadia Alam Shammi, et al., Ecological Indicators, Volume 121, February 2021). The growth stage at the time t1 is derivable from the satellite imaging data, preferably the crop vegetation indexes, at the time t1 by regression analysis in analogy to what has been described for the crop classification data, especially by using annotated reference data, such as by using a machine-learning based model trained with annotated reference data comprising information on the crop growth stage.

The term “product consumption model” is to be understood broadly in the present disclosure and refers to any computer-operable model, method, mathematical algorithm, which can be used to calculate/estimate a consumption of the agricultural product for a specific point in time or a time period. Such a product consumption may be at least based on the future crop data comprising information on the area of the geographic region cultivated with a specific crop. However, it is not excluded that further parameters are used in the product consumption model. Especially, the product consumption model may use the result of a crop growth model to determine the exact timing when the agrochemical product will be required. Accordingly, the product consumption model may use as input parameters the estimated crop growth stage at a time t₂ as determined by the crop growth model, besides the future crop data.

In addition, shelf-life data of the agricultural products, expected planting decision of the farmers, pest and disease pressure data, regulatory data for the agricultural products and the like can be taken into account here in order to improve the accuracy of the product consumption estimation. The relation between the determined area and the demand for an agricultural product during a season may be derived from historically observed demand patterns as well as empirical experience, e.g. as explained in the “Pflanzenschutzberater—Kloster Mühle” in which the usual use of various agricultural products in the different plant states are explained. In this context, however, a large number of other sources/recommendations are known which can be used here. In addition, a consumption model specialized or trained for this purpose can be used for each agricultural product. For example, a consumption model for herbicides, a consumption model for fertilizers, a consumption model for pesticides, etc., can be used. However, these consumption models can also be combined into a single consumption model. In an example, a consumption model may be provided, by the standard recommended application rates, e.g. for Cantus Gold, a fungicide for the treatment of ripening diseases in oilseed rape a standard application rate of 0.5 I/ha is recommended.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device or processing unit to perform the respective action. As used in the term “determining [. . . ] by a / the processing unit”, the “determining” relates to an automatic determination performed by the processing unit without human interaction.

### DETAILED DESCRIPTION OF THE INVENTION AND PREFERRED EMBODIMENTS

The inventive method (100) aims at estimating the consumption of an agricultural product. The agricultural product may be a fungicide, an herbicide, an insecticide, an acaricide, a molluscicide, a nematicide, an avicide, a piscicide, a rodenticide, a repellant, a bactericide, a biocide, a safener, a plant growth regulator, a urease inhibitor, a nitrification inhibitor, a denitrification inhibitor, a fertilizer, a nutrient, a seed/seedling, and/or combination thereof. In one embodiment, the agricultural product is a fungicide. In another embodiment, the agricultural product is a plant propagation material, such as seeds.

The first step (110) of the inventive method (100) relates to the provision of historic satellite imaging data of the geographic region. In one embodiment, the historic satellite imaging data is based on data obtained by using Synthetic Aperture Radar (SAR), or Light Detection and Ranging (LIDAR) via satellites.

In one embodiment, the historic satellite imaging data comprises time-resolved imaging data. The term time-resolved imaging data relates to a series of imaging data captured over the previous growing season and at least one further historic growing season, preferably a series of imaging data for both the previous growing season and the at least one further historic growing season. The accuracy of the inventive objects as described herein increases by the number of measurements per growing period. Typically, one set of imaging data of a field per week is captured over a growing period.

The historic satellite imaging data comprises data of at least the previous growing season and one further historic growing season. Typically, the historic satellite imaging data comprises data of at least the two previous growing seasons. In one embodiment, the historic satellite imaging data data is of the at least three previous growing seasons, preferably the at least four previous growing seasons, more preferably the at least five previous growing seasons, especially at least the last six previous growing seasons. It is to be understood that the method will yield more reliable results with higher numbers of previous growing seasons for which historic crop vegetation index data is available.

In a second step (120), the inventive method (100) determines historic crop classification data from at least the historic satellite imaging data.

In one embodiment, step (120) comprises the step of determining (125) from the satellite imaging data, historic time-resolved vegetation index data, followed by a determination of information on the crop types grown on the agricultural fields in the geographic region for the at least two historic growing seasons from the vegetation index data.

Vegetation indices typically put the intensity of certain light waves into relation to provide certain information on the growth stage, health, nutrition, water supply and other important features of the crop plant. Their calculation from imaging data are known to the skilled person and have for example been described in https://en.wikipedia.org/wiki/Vegetation_Index or in https://earthobservatory.nasa.gov/features/MeasuringVegetation/measuring vegetation 2.php.

In one embodiment, the historic satellite imaging data is time-resolved imaging data, and the historic vegetation index data is time-resolved vegetation index data selected from Normalized Difference Vegetation Index (NDVI) Data and/or Leaf Area Index (LAI) Data, Normalized Difference Water Index (NDWI), Enhanced Vegetation Index (EVI) Data.

The classification of plants grown on an agricultural field can be made with high accuracy from satellite imaging data, preferably vegetation index data. Accordingly, it is possible to determine, by means of a processing unit, which kind of plant is grown on an agricultural field. The determination (120, 125) may be achieved by using a classification model. The classification model is obtainable by various methods, such as machine-learning, especially supervised learning by using reference data. Techniques useful for supervised learning to yield classification models are logistic regression, a perceptron algorithm, Bayes classification, naïve Bayes classification, k-nearest neighbor algorithm, artificial neural networks and decision-tree based modeling such as random forest algorithms. Reference data for generating suitable models is typically obtained by annotation of satellite imaging data with ground truth data gathered by agronomic advisors, users, or field-based machinery such as the BASF Smart Sprayer.

Highest accuracy of the prediction is typically achieved by using time-resolved satellite imaging data, preferably vegetation index data, to determine the type of crop plant growing on it. In case a vegetation index is used, a single index like the NDVI or the LAI index might be sufficient. However, a combination of various vegetation indexes does of course increase the accuracy of the determination considerably.

Other methods useful in step (120, 125) are a wide range of statistical modelling approaches. The accuracy achievable with such methods is typically at least 90%, usually at least 95%. A high accuracy of the determination of step (120, 125) is particularly important since even a small error would cause considerable insecurities if a high number of agricultural fields are assessed.

Accordingly, the determination in step (120, 125) would first result in a certain probability that a crop plant was grown on the agricultural fields. This information may be provided in steps (130) and (150) directly. Alternatively, the agricultural field may be classified based on a pre-defined benchmark as a field where the crop plant had or had not been grown during at least one previous growing period, and this classified information may then be provided in steps (130) and (150).

The inventive method may typically include a step (115) of determining field boundaries in the historic satellite imaging data. This step may typically be carried out after step (110) and before step 120. However, it is also possible to perform step (115) after step (120), such as before step (125) or after step (125) and before step (130).

Such a determination may be achieved by a field boundary detection model. Field boundary detection models are typically obtained by using supervised machine-learning. Suitable machine-learning approaches include deep learning techniques, in particular the use of convolutional neural networks for segmentation, e.g. UNet or ResUNet-a (Diakogiannis, F. I., Waldner, F., Caccetta, P., Wu, C., 2019. Resunet-a: a deep learning framework for semantic segmentation of remotely sensed data. arXiv preprint arXiv:1904.00592; https://www.tensorflow.org/).

Training images for these supervised machine-learning approaches should be as homogeneous as possible by selecting the observation with least cloud coverage from a specified interval, e.g. within 3 months. Gaps in the selected observation due to clouds may be filled with other, unclouded observations. This approach may generate images which are both complete and have a minimum of artificial disturbances in the image which would occur freely combining images from different observation dates. Additionally, to indicate artificial disturbances from replacements to the model, an extra layer encoding the time of observation of each pixel may be created. Thus, the model can learn to identify disturbances. Furthermore, Sobel filters applied to the individual satellite bands are typically generated, to enhance the visibility of optical edges in the image.

The chosen training data in vector format is typically rasterized to match the satellite data. Three different targets may be derived to train the model as described in Waldner et al. (Deep learning on edge: extracting field boundaries from satellite images with a convolutional neural network; 2020; arXiv preprint arXiv:1910.12023v2): a binary mask of the field boundaries, a binary mask of the extent of the fields and a field-wise normalized distance (distance to closest boundary).

To train the models, satellite data and training data may be sliced down to smaller portions (e.g. 128×128 pixel images) to fit into GPU memory. The models, which are based on the tensorflow library (www. tensorflow. org), are typically optimized by minimizing Tanimoto loss (see Waldner, F., Diakogiannis, F. I., 2020: Deep learning on edge: extracting field boundaries from satellite images with a convolutional neural network. arXiv preprint arXiv:1910.12023v2).

The trained segmentation models may then be used to derive field boundary predictions and field extent predictions for targeted new areas. They typically make use of the mechanisms previously described for the training process. Satellite images are chosen, preprocessed, and sliced down to generate the input for inference. Inference is performed independently on multiple timepoints of one or multiple seasons to mitigate altering appearances of agricultural fields due to vegetative processes throughout the year. Afterwards, those predictions on slices are rejoined to larger units (tiles).

The field boundary predictions may be finally combined to generates field boundaries in vector format. The individual predictions of an area at different time points may be merged (e.g. via mean or max operation), artificially magnified to a higher resolution (e.g. from 10 m to 2 m) and smoothed. The magnification allows the system to compensate for the effects of the coarse pixels of satellite data yielding smoother field boundaries. The probabilistic model predictions with continuous values from 0 to 1 are classified by thresholds to yield binary values. Subsequently, these binary masks may then be combined to a final field boundary mask by subtracting the binary field boundary predictions from the binary field extent predictions. Finally, the segments in raster format are vectorized and minor adjustments may be performed, like smoothing of the boundaries and filling smaller gaps in fields. The obtained field boundaries are stored on a file storage and referenced in a database, to allow for easy access and usage.

In a subsequent step (130), a crop rotation model for classifying crop rotation patterns in the geographic region is provided, wherein the model is at least based on the historic crop classification data for the geographic region.

In a subsequent step (140), crop rotation patterns of agricultural fields, i.e. individual agricultural fields, in the geographic region are determined. The determination is achieved by using the crop rotation model and the historic crop classification data. This is usually done by comparing the historic crop classification data of the agricultural field with the different crop rotation patterns within the crop rotation model and classifying the field according to the crop rotation pattern that best describes the historic crop classification data. The accuracy of the inventive method rises if the historic crop classification data is not just on the last growing season and one further historic growing season, but on at least the two last growing seasons, preferably at least the three last growing seasons, more preferably at least the last four growing seasons, such as at least the last five growing seasons.

In a next step (150), the method involves the determining of future crop data comprising information on the area of the geographic region cultivated with a specific crop in the current or the next growing season at least based on the historic crop classification data of the agricultural fields by using the crop rotation patterns of the agricultural fields. In other words, the future crop data comprise information on the type of crop that is already growing, or that will be grown on certain areas in the geographic region. For example, the future crop data may contain the information on which areas in a geographic region winter wheat is currently grown or will be grown in the next growing season. For the avoidance of doubt, it is to be emphasized that the term “current growing season” refers to the situation when the growing season has already begun but seeding of crop has not yet been carried out, or seeding has already been carried out but the seedlings have not emerged above the soil, yet, or wherein the seedlings are still too small to allow for a crop classification based on crop vegetation index data. In other words, the term “current growing season” refers to the situation where the growing season has already begun, but the crop classification data of the agricultural field by means of crop vegetation index data cannot be obtained yet. Preferably, the future crop data comprises information on the area of the geographic region cultivated with a specific crop in the next growing season.

The future crop data is obtained from the historic crop classification data by using the crop rotation patterns of the agricultural fields. In other words, the historic crop classification data for one, a plurality, or even all agricultural fields of the geographic region are compared with the crop rotation patterns of the agricultural fields to determine in which stage of the crop rotation cycle the fields are currently cultivated, whereupon it is anticipated, based on the crop rotation patterns of said fields, which crop type is cultivated in the current, or will be cultivated in the next growing season. For example, if the crop rotation pattern of a field would follow the sequence -(A-B-C)-, and it is further determined in the historic crop classification data that the field was last cultivated with crop B, and in the previous year with crop A, then the future crop data would indicate that crop C will be grown in the next growing season. Since the future crop data is a prediction based on the crop rotation model, it is usually connected to a certain accuracy, which may vary with the amount of underlying data. Accordingly, the data accuracy may also be determined and further used in the subsequent steps of the inventive model.

The future crop data may be determined for one specific crop, several specific crops, or for all crops grown on agricultural fields in the geographic region. In one embodiment, the future crop data is determined for areas in the geographic region cultivated with one specific crop.

In an embodiment of the computer-implemented method for estimating a consumption of an agricultural product, future crop data are determined for a preselected group of specific crops. In an example, the preselected group of specific crops is the combination of winter oilseed rape, winter roe, sugar beet and winter wheat which are determined in parallel.

In a next step (160), the method involves the provision of a product consumption model for the agricultural product configured to estimate a consumption of the agricultural product at least based on the future crop data. In subsequent step (170), the method involves providing an estimation of the consumption of the agricultural product for the geographic region at least based on the future crop data using the product consumption model.

In one embodiment, the product consumption model for the area cultivated with the specific crop is based on the results of a machine-learning algorithm configured to estimate the consumption of the agricultural product at least based on the area of the geographical region cultivated with the specific crop. However, it is also possible to use a statistics-based product consumption model. Moreover, such a product consumption model is not limited to use the area only, i.e. further data may be used in this respect. Shelf life data of the agricultural products, expected planting decision of the farmers, pest and disease pressure data, regulatory data for the agricultural products and the like can be taken into account here in order to improve the accuracy of the product consumption estimation.

In one embodiment, the computer-implemented method further comprises at least one of the following steps:
providing stock recommendation data for a minimum stock level of the agricultural product at a specific time and/or for a time period based on the estimation of the consumption of the agricultural product; and/or
providing stock recommendation data for a minimum stock level of base materials necessary for the production of the agricultural product at a specific time and/or for a time period based on the estimation of the consumption of the agricultural product; and/or
providing production recommendation data for producing the agricultural product based on the estimation of the consumption of the agricultural product; and/or
providing order recommendation data for ordering an amount of the agricultural product and/or an amount of base materials necessary for the production of the agricultural product based on the estimation of the consumption of the agricultural product; and/or
providing overview data for agricultural products needed and/or recommended for the specific crop; and/or
providing control data for a manufacturing process, logistics process and/or warehouse process with respect to the agricultural product based on the estimation of the consumption of the agricultural product.

### BRIEF DESCRIPTION OF THE DRAWINGS

In the following, the present disclosure is further described with reference to the enclosed figures:

FIG. 1 is a flow diagram of an example method for estimating a consumption of an agricultural product for a geographical region;

FIG. 2 is a schematic illustration of the time-resolved pattern of a vegetation index useful for identifying a crop plant growing on the field

FIG. 3 is a schematic illustration of an ensemble of agricultural fields for which the consumption of an agricultural product is to be estimated;

FIG. 4 is a diagram showing the probability of certain crop rotation patterns in a geographic region;

FIG. 5 is a grey-scale satellite image of an agricultural area, wherein those fields have been indicated in light grey where future crop data indicates that oilseed rape will be grown in the next growing season.

### DETAILED DESCRIPTION OF EMBODIMENT

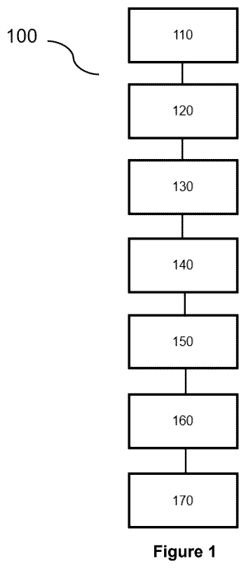

FIG. 1 is a flow diagram of an example method 100 for estimating a consumption of an agricultural product for a geographical region. For example, the agricultural product is a fungicide, an herbicide, an insecticide, an acaricide, a molluscicide, a nematicide, an avicide, a piscicide, a rodenticide, a repellant, a bactericide, a biocide, a safener, a plant growth regulator, a urease inhibitor, a nitrification inhibitor, a denitrification inhibitor, a fertilizer, a nutrient, a seed/seedling, and/or combination thereof.

In a first step 110, historic satellite imaging data for a geographical region, e.g. Bavaria, is provided. Satellite imaging data is publicly available. The historic satellite imaging data may be provided for the last growing season, e.g. the last year, and a further historic growing season, e.g. the year before last year. Typically, the historic satellite imaging data is at least provided for the last three growing periods, e.g. the last three years.

The historic satellite imaging data is typically time-resolved, i.e. it contains crop vegetation index data for a series of points in time. For example, the historic satellite imaging data may contain data for a time period of 2 weeks starting 15 days after seeding for each covered growing season. By taking into account not only a point in time but a time period, the accuracy of the determination of which areas have been planted with which specific crop may be significantly improved.

In a step 120, historic crop classification data is determined from the historic satellite imaging data. In a first step (125), crop vegetation index data may be derived from the satellite imaging data. The determination (125) of crop vegetation index data from satellite imaging data will be described in detail further below.

The historic crop vegetation index data may be Normalized Difference Vegetation Index (NDVI) data, Leaf Area Index (LAI) data, Normalized Difference Water Index (NDWI) data, Enhanced Vegetation Index (EVI) data, or a mixture thereof. Preferably the historic crop vegetation index data comprises historic NDVI data.

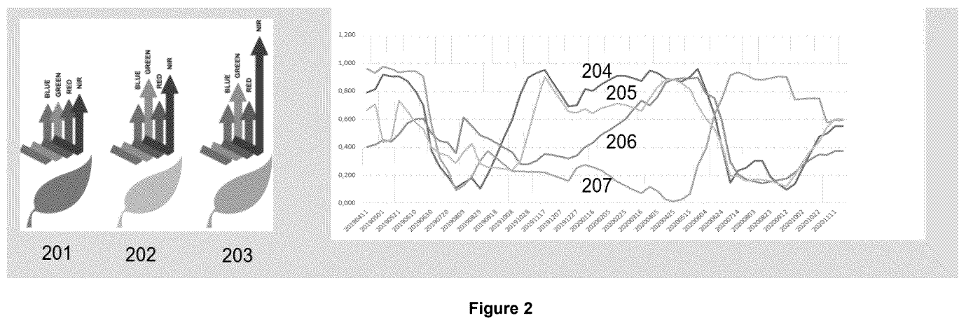

As outlined above, classification of agricultural fields by crop type from the satellite imaging data, preferably the crop vegetation index data, can be achieved by various statistical methods, for example by comparison with reference data. This can be put into practice by using a machine-learning-based model. Such machine-learning-based models are typically obtainable by using annotated satellite imaging data as a training dataset, wherein the annotation is based on ground truth data collected by farmers, or agronomic advisors. The modelling and classification will be discussed and illustrated by FIG. 2. Accordingly, the historic crop classification data contains the information which crop type was grown on a certain area of the geographic region. For example, the historic crop classification data may contain the information which crops were grown on a specific agricultural field over the last seasons, e.g. the last three or four years. For one specific field, such information may be that barley was grown in year one, followed by chickpeas in year two, followed by clover in year three, and again barley in year four-last year. The aggregated information of all agricultural fields within the geographic region would then represent the historic crop classification data.

In subsequent step (130), the historic crop classification data is used to set-up a crop rotation model for the geographic region. To this end, the historic crop classification data is analyzed for crop rotation patterns. In other words, the historic crop classification data is further classified based on field level to assign the agricultural fields to certain crop rotation patterns. The crop rotation model may further assign frequency or likelihood data to the crop rotation patterns.

Such crop rotation patterns may directly reflect the sequence of crop types grown on the agricultural fields, but it may also be based on further aspects as outlines above. For example, the crop rotation model may contain crop rotation patterns that are established to ensure a good soil quality by terms of nutrients, e.g. nitrogen or carbon content, pest management, e.g. crop-specific fungal diseases like Sclerotinia fungi, and soil erosion, e.g. by unfarmed soil. The crop rotation model may also include recommendations by authorities.

Subsequently, the crop rotation pattern for each agricultural field is determined (140). This step is achieved by inputting the historic crop classification of the agricultural field into the crop rotation model. In other words, the sequence of crop plants grown on an agricultural field over the last years is compared with all known patterns of crop rotation contained in the crop rotation model, and the most likely crop rotation pattern for the particular agricultural field is determined. For example, the crop rotation model may contain information that two crop rotation patterns exist in a geographic region, e.g. a pattern -A-B- and a pattern -A-B-C-, wherein the pattern -A-B-C- prevails by a likelihood of 80% over all fields. In one example, the historic classification data may indicate that crop A was used last year, and crop C was grown the year before last year. In turn, the crop rotation pattern -A-B-C- is selected and further used in the subsequent steps.

By other way of example, the historic crop classification data may indicate that crop B was grown last year, whereas crop A was grown in the year before last year. Since the historic crop classification data cannot distinguish between the two crop rotation patterns, the more likely rotation pattern of -A-B-C- is further used, preferably with the annotation that this information has an 80% likelihood.

The crop rotation pattern is determined for the majority-preferably all-agricultural fields in the geographic region.

In a further step (150), future crop data are determined. To this end, the crop rotation pattern of each individual field is compared with the historic crop classification data. For example, if it has been determined that a particular field would fall under the pattern -A-B-C-, and if the historic crop classification data would indicate that crop B was grown on the agricultural field last year, it would be determined that crop C would be grown on the agricultural field next season. This procedure is carried out for the majority—preferably all—agricultural fields in the geographic region, and the thus obtained data is compiled to obtain the future crop data of the geographic region. Accordingly, the future crop data may contain information for the most likely crop type that will be grown on each agricultural field in the geographic region. At least, the future crop data may only contain information on which agricultural fields in the geographic region a specific crop will be grown. In one embodiment, the future crop data may contain information on all crop types for which a specific agricultural product may be applied.

In a step 160, a product consumption model for the agricultural product is provided, wherein the product consumption model is configured to estimate a consumption of the agricultural product at least based on the future crop data. For example, a consumption model for Cantus Gold, a fungicide for the treatment of ripening diseases in oilseed rape, is provided. The product consumption model may be based on the results of a machine-learning algorithm for estimating a consumption of the agricultural product. However, it is also possible to use a statistics-based product consumption model. Moreover, such a product consumption model is not limited to use the area only, i.e. further data may be used in this respect. Shelf life data of the agricultural products, expected planting decision of the farmers, pest and disease pressure data, regulatory data for the agricultural products and the like can be taken into account here in order to improve the accuracy of the product consumption estimation.

In a step 170, an estimation of the consumption of the agricultural product for the area cultivated with the specific crop is performed. For example, in case, it has been determined that in the geographic region 1000 hectare will be cultivated with oilseed rape next season as contained in the future crop data, an estimation of the consumption of Cantus Gold can be provided.

FIG. 2 shows the development of the NDVI index over a season. The NDVI vegetation index takes into account the relation of intensity of different spectral areas in an image, in particular the near infrared and the visible red-light parts of the spectrum and puts them into relation. The NDVI index of a plant varies during the season as displayed in the left window of FIG. 2. For a green, healthy leaf (203), the NIR intensity is rather high as compared to the red-light parts of the spectrum. This is different for young leaves (202) or brown leaves (201). On the right-hand side of FIG. 2, time-resolved data series of NDVI values over one season are shown for different crops plants (204, 205, 206, 207). Depending on the growth cycle of the plant, the NDVI has a very specific pattern for each plant. For example, some crop plants start to germinate and grow at a different point in time during the season. As can be seen from curve (204), the onset of the curve is rather early and abrupt at the beginning of the winter season, whereas curve (206) would rise slowly and steadily during the winter season. Finally, NDVI curve (207) would only raise in the summer months beginning of June. Whereas the distinct patterns for different crop plants is only shown for the NDVI index, it is also present in other vegetation indexes like the LAI index.

These patterns can be used to identify the type of crop plant grown on a field. It is not necessary to record the entire time-resolved pattern of the indexes, but the more datapoints are available the higher the accuracy of the information will be. Typically, not only one vegetation index is used as input factor, but an array of vegetation index factors. As mentioned earlier, an annotated form of the historic vegetation index data may be used as training dataset to generate a machine-learning model. The annotation can be achieved be recording farmer data, such as with a customer frontend tool like the BASF Xarvio suite. It may also be achieved by using observation data obtained by sales representatives. The annotated training data may be used for supervised machine-learning approaches. For example, training data may comprise historic vegetation index data of a geographic area, wherein certain agricultural fields have been annotated with the type of crop growing on said field, and the time during the season when the image was captured, preferably wherein the imaging data is time-resolved and contains at least imaging data of two points in time during the season. The machine-learning tools typically use a loss-function to generate a model that describes the training data in the best way possible. Typically, validation data is used to avoid overfitting. The thus obtained model can then be used to analyze newly captured satellite imaging data.

If no machine-learning approach is used, it may be advisable to generate calibration curves of vegetation indexes from annotated training data, such as by determining the mean of various curves captured for the same crop plant. The calibration curves may then be used in a regression approach to classify new data according to the pre-defined calibration curves. Typically, this is achieved by minimizing the deviation of the newly measured curve from the calibration curves and classifying the field according to the fit with the smallest deviation. Accordingly, the historic crop vegetation index data can be analyzed to classify the crop plants grown on the agricultural field during a previous growing period.

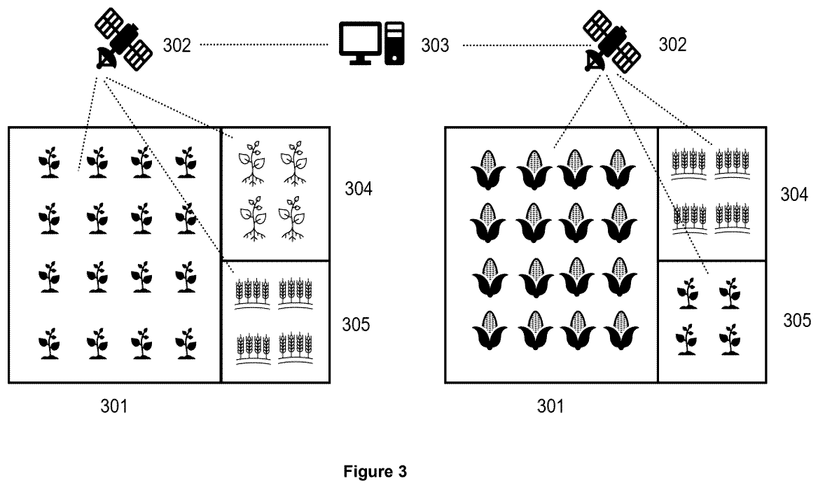

FIG. 3 shows an ensemble of agricultural fields 301, 304, 305, for which imaging data is captured by a satellite 302. The imaging data is then transferred to a server 303, such as a local server or a cloud computing environment. The agricultural fields are being cultivated in a crop rotation system. I year one (left panel), oilseed rape is grown on field 301, chickpeas are grown on field 304, and ray is grown on field 305. In the next year, corn is grown on field 301, ray is grown on field 304, and oilseed rape is grown on field 305. For each of the fields 301, 304, 305, a different crop is grown in the second year as compared to the first year. It may thus be assumed, that a crop rotation pattern may exist, but it is still unclear how such a pattern might be usable for forecasting the crop type that will be grown on a field next season. However, the historic crop classification data may be combined with further crop rotation information. For example, if a four-field crop rotation system was assumed, it would be likely that field 301 would be either cultivated with chickpea or ray next season, i.e. there would be a probability of 50%. If further information, e.g. on nitrogen management, were considered, the probability might be even further influenced, e.g. 80% ray vs. 20% chickpea. Accordingly, if the crop rotation model for a geographic region indicates that more than 90% of farmers use a four-field system, and if further the historic crop rotation data for a particular field would allow for the same assumption for said field, it might be possible-even with very limited data-to generate a moderate to high-accuracy assumption on the crop type that will be grown on an agricultural field in the next season. As outlined above, the quality of the prediction will be higher with higher amounts of underlying data and will require less a priori knowledge to yield acceptable results. For example, historic crop classification data of the last 6-10 growing seasons will yield a highly accurate assumption of a crop rotation pattern of a field.

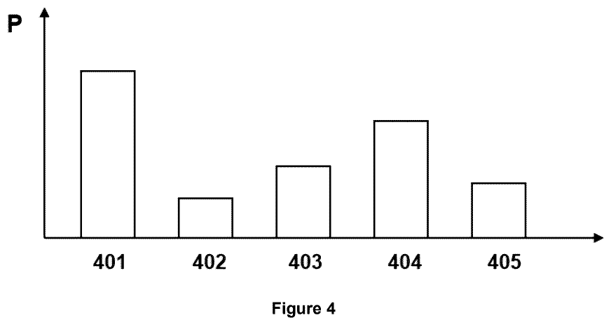

FIG. 4 is a diagram showing the probability (P) of different crop rotation patterns (401, 402, 403, 404, 405) for a geographic region. This information may reflect a crop rotation model for a geographic region that is entirely based on empiric data, i.e. historic crop classification data. The crop rotation model may contain the probabilities of each crop rotation pattern found in the geographic region, or it may just compile all observed patterns, preferably in addition to further a priori data on crop rotation management to optimize soil health (carbon or nitrogen content), reduce pest damages, reduce soil erosion, reduce effects on, or of neighboring fields etc.

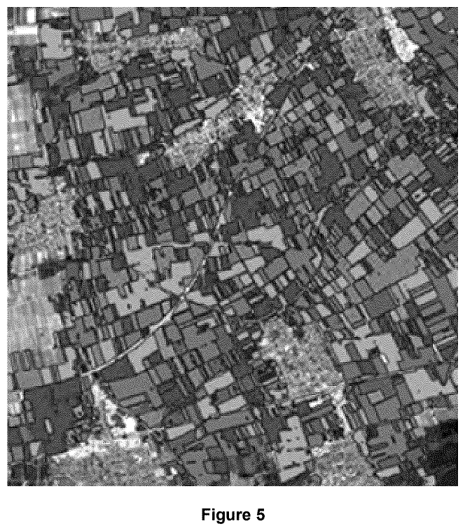

FIG. 5 is a grey-scale satellite image of an agricultural area, wherein those fields have been indicated in light grey where future crop data indicates that oilseed rape will be grown in the next growing season. Accordingly, FIG. 5 is an illustration of future crop data of a geographic region. As indicated above, the future crop data may contain information on agricultural fields on which one specific crop is currently grown, or will be grown in the next growth season, or it may contain information on several crop types. Preferably, it may contain information on all crop types that are relevant for estimating the consumption of the specific agricultural product in question. For example, a fungicide may be admitted for treatment of fungal diseases in different related species, such as in oilseed rape and white mustard. For estimating the consumption of the fungicide, it is important to know the size of the area on which white mustard and oilseed rape will be grown in the geographic region of interest.

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for estimating a consumption of an agricultural product for a geographical region, the method comprising the steps:
providing historic satellite imaging data for the geographical region of the previous growing season and at least one further historic growing season;
determining historic crop classification data from at least the historic satellite imaging data, the historic crop classification data comprising information on the crop types grown on the agricultural fields in the geographic region for the at least two historic growing seasons;
providing a crop rotation model for classifying crop rotation patterns in the geographic region, the model at least being based on the historic crop classification data for the geographic region;
determining crop rotation patterns of agricultural fields in the geographic region based on the historic crop classification data of the agricultural fields by using the crop rotation model;
determining future crop data comprising information on the area of the geographic region cultivated with a specific crop in the current or the next growing season at least based on the historic crop classification data of the agricultural fields by using the crop rotation patterns of the agricultural fields;
providing a product consumption model for the agricultural product configured to estimate a consumption of the agricultural product at least based on the future crop data; and
providing an estimation of the consumption of the agricultural product for the geographical region at least based on the future crop data using the product consumption model;
wherein the geographical region is an area of more than 400 square kilometers.

2. The computer-implemented method according to claim 1, wherein the historic satellite imaging data comprises time-resolved imaging data of the at least two historic growing seasons.

3. The method of claim 1, wherein determining historic crop classification data comprises the step of determining of historic vegetation index data from the satellite imaging data, followed by a determination of information on the crop types grown on the agricultural fields in the geographic region for the at least two historic growing seasons from the vegetation index data.

4. The computer-implemented method according to claim 3, wherein the historic crop vegetation index data comprises time-resolved crop vegetation index data selected from Normalized Difference Vegetation Index (NDVI) Data and/or Leaf Area Index (LAI) Data, Normalized Difference Water Index (NDWI), or Enhanced Vegetation Index (EVI) Data.

5. The computer-implemented method according to claim 1, wherein the historic satellite imaging data is of the at least three previous growing seasons.

6. The computer-implemented method according to claim 1, wherein the agricultural product is a fungicide, an herbicide, an insecticide, an acaricide, a molluscicide, a nematicide, an avicide, a piscicide, a rodenticide, a repellant, a bactericide, a biocide, a safener, a plant growth regulator, a urease inhibitor, a nitrification inhibitor, a denitrification inhibitor, a fertilizer, a nutrient, a seed/seedling, and/or combination thereof.

7. The computer-implemented method according to claim 1, wherein historic satellite imaging data are based on data obtained by using Synthetic Aperture Radar (SAR), or Light Detection and Ranging (LIDAR) via satellites.

8. The computer-implemented method according to claim 1, wherein the product consumption model for the area cultivated with the specific crop is based on the results of a machine-learning algorithm configured to estimate the consumption of the agricultural product at least based on the area of the geographical region cultivated with the specific crop.

9. The computer-implemented method according to claim 1, further comprising at least one of the following steps:
providing stock recommendation data for a minimum stock level of the agricultural product at a specific time and/or for a time period based on the estimation of the consumption of the agricultural product; and/or
providing stock recommendation data for a minimum stock level of base materials necessary for the production of the agricultural product at a specific time and/or for a time period based on the estimation of the consumption of the agricultural product; and/or
providing production recommendation data for producing the agricultural product based on the estimation of the consumption of the agricultural product; and/or
providing order recommendation data for ordering an amount of the agricultural product and/or an amount of base materials necessary for the production of the agricultural product based on the estimation of the consumption of the agricultural product; and/or
providing overview data for agricultural products needed and/or recommended for the specific crop; and/or
providing control data for a manufacturing process, logistics process and/or warehouse process with respect to the agricultural product based on the estimation of the consumption of the agricultural product.

10. The computer-implemented method according to claim 1, wherein the future crop data is determined for areas in the geographic region cultivated with one specific crop.

11. (canceled)

12. A system for estimating a consumption of an agricultural product for a geographic region, the system comprising:
one or more computing nodes and one or more computer-readable media having thereon computer-executable instructions that are structured such that, when executed by the one or more computing nodes, cause the system to perform the following steps:
providing satellite imaging data for the geographical region of the previous growing season and at least one further historic growing season;
determining historic crop classification data from at least the historic satellite imaging data, the historic crop classification data comprising information on the crop types grown on the agricultural fields in the geographic region for the at least two historic growing seasons;
providing a crop rotation model for classifying crop rotation patterns in the geographic region, the model at least being based on the historic crop classification data for the geographic region;
determining crop rotation patterns of agricultural fields in the geographic region based on the historic crop classification data of the agricultural fields by using the crop rotation model;
determining future crop data comprising information on the area of the geographic region cultivated with a specific crop in the current or the next growing season at least based on the historic crop classification data of the agricultural fields by using the crop rotation patterns of the agricultural fields;
providing a product consumption model for the agricultural product configured to estimate a consumption of the agricultural product at least based on the future crop data; and
providing an estimation of the consumption of the agricultural product for the geographical region at least based on the future crop data using the product consumption model.

13. A computer program element with instructions, which when executed on one or more computing node(s) is configured to carry out the steps of the method of claim 1.

14. A computer readable medium having stored the computer program element of claim 13.

15. A computer program element with instructions, which when executed on one or more computing node(s) is configured to carry out the steps of the system of claim 12.
